(19) United States
(12) Patent Application Publication
(10) Pub. No.: US 2009/0193991 A1
(43) Pub. Date: Aug. 6, 2009

(54) BLANKET SLEEVE AND CYLINDER AND METHOD OF MAKING SAME

(76) Inventor: FELICE ROSSINI, Millano (IT)

Correspondence Address: DORITY & MANNING, P.A., POST OFFICE BOX 1449, GREENVILLE, SC, 29602-1449, US

(21) Appl. No.: 12/135,405

(22) Filed: Jun. 9, 2008

Related U.S. Application Data
(60) Provisional application No. 61/026,021, filed on Feb. 4, 2008.

(51) Int. Cl. B41N 1/00

(52) U.S. Cl. 101/453

(57) ABSTRACT

A sleeve is provided to be drawn over a rotary support in order to define a blanket cylinder of an indirect or offset printing machine in which the blanket cylinder cooperates with a lithographic plate cylinder from which the sleeve receives the data to be printed onto a substrate which moves between the blanket cylinder and a pressure cylinder. The sleeve comprises an inner cylindrical portion configured to be drawn over the aforesaid rotary support. The outer surface of the inner cylindrical portion is covered by a single layer structure that cooperates directly with the lithographic plate and with the substrate to be printed. The single layer structure is composed at least partly of polyurethane material and cells occupying no less than about 0.6 percent by weight and no more than about 4.4 percent by weight and uniformly dispersed throughout the single layer. The single layer is formed of a precursor that is deposited by ribbon technology onto the outer surface of the inner cylindrical portion. The precursor includes two components. The first component includes polyol and microspheres wherein the microspheres constitute between about 1 percent by weight of the first component and about 6 percent by weight of the first component. The second component includes a curing agent for the polyol such that the weight ratio of the first component to the second component is in the range of about 100:38 to about 100:60.

### RELATED APPLICATIONS

Benefit is hereby claimed to provisional patent application Ser. No. 61-026,021, filed on Feb. 4, 2008.

### BACKGROUND OF THE INVENTION

The present invention relates to a sleeve for an indirect or offset printing machine and in particular to a sleeve to be carried on an offset blanket cylinder as well as to methods for making such sleeves.

Offset printing machines or lithographic rotary printing machines with indirect printing are known, and examples are schematically represented in FIGS. 1 of U.S. Pat. Nos. 5,440,981 and 5,429,048, which patents are hereby incorporated herein in their entirety for all purposes by this reference. It is known that an offset machine or a lithographic rotary machine with indirect printing mainly comprises three rigid cylinders, usually made of steel. A first cylinder carries lithographic plates that, after being disposed into contact with inking rollers and wetting rollers, carry ink on some portions of the plates and an absence of ink on other portions of the plates and thus carry inked data thereon. A second, subsidiary cylinder (or blanket cylinder) receives the inked data to be printed (i.e., “the impression”) from the first cylinder. These data are transferred to a substrate or web of paper or other material (for example plastic), which is interposed between the blanket cylinder and a third cylinder, which commonly is known as the backing cylinder if only one side of the substrate is to be printed. If both sides of the substrate are to be printed, then two blanket cylinders are employed. After transforming the inked data to the substrate, the surface of each blanket cylinder passes through a bath of solvents that wash the residual ink from the surface of the blanket cylinder. Over time, the ink, which can be acetate-based or alcohol-based, and the solvents tend to degrade the materials forming the blanket cylinder.

The blanket cylinder acquired this name because the rigid blanket cylinder of the printing machine is usually covered with a natural rubber blanket, which can have either a “compressible” structure, i.e., with a compressible layer, or a “conventional” structure, i.e., without a compressible layer. Various methods (and corresponding products) for producing the blanket cylinder are known. One of these methods uses a blanket in the form of a flat sheet composed of natural rubber with a yieldable (compressible) structure. The cylinder's surface has an axial slot disposed parallel to the longitudinal axis. The rubber is wrapped about the blanket cylinder with the ends of the sheet of rubber inserted into the slot and fixed to the cylinder by inserting a bar into the axial slot to retain the ends of the rubber therein.

The use of this type of blanket cylinder gives rise to various problems, which for the most part arise due to the asymmetry of the slot in the outer surface of the rotating cylinder during operation of the printing machine. Accordingly, this known method and resultant solution was later overtaken by other solutions.

For example, offset presses began using a rotary support or mandrel that carries a cylindrical blanket sleeve, which together with the mandrel function as the blanket cylinder. This blanket sleeve includes an inner cylindrical portion or core that is formed as a hollow cylindrical body or sleeve. The core is typically formed of a thin-walled nickel tube that has a radial thickness in the range of seven thousandths of an inch thick to ten thousandths of an inch. The core is configured to be selectively drawn over the mandrel and locked to the mandrel. Thus, the blanket sleeve can be mounted on and dismounted from the mandrel, as by pressurized air for example, and therefore is independent from the rotary mandrel of the offset press. The blanket sleeve includes a compressible layer positioned on the inner cylindrical portion (core), a substantially incompressible reinforcement layer positioned on the compressible layer, and finally a printing layer that receives the inked data.

The compressible layer comprises a first continuous tubular body (without joints) of elastomeric material (nitrile rubber, e.g., acrylo-nitrile butadiene) presenting internally a plurality of cavities that determine the “compressibility” of the layer. To produce this compressible layer on the inner cylinder (core) first requires placing the nitrile rubber material into solution to form a liquid. This is accomplished by adding solvents to the solid nitrile rubber to provide the nitrile rubber in liquid solution. Then microspheres (that ultimately will produce the desired cavities in the compressible layer) are mixed into that nitrile rubber solution. Then, in a very time consuming process that requires considerable operator skill, the nitrile rubber solution with the microspheres is applied to the surface of the inner cylinder (core) by a knife coating technology or ring coating technology for example to build up a precursor layer of about one millimeter in radial thickness. However, because nitrile rubber does not adhere well to nickel surfaces, when the core is formed of nickel, an adhesive preparation must be provided. For example, a liquid adhesive paint is typically first applied to the surface of the nickel core, and the nitrile rubber solution is applied to the exposed surface of the coating of liquid adhesive paint rather than to the bare nickel surface.

The use of a knife coating technology to produce this precursor layer requires an operator to mount the core onto a rotating mandrel. As the mandrel rotates, the operator must apply the liquid rubber solution with the microspheres to the surface of the rotating core. At the same time, a knife blade rises automatically to even out the surface being created while heated air is applied to remove the solvent from the solution as the core is rotating. The amount of solution being applied by the operator will vary depending on the consistency of the solution. If the solution is running it will not form the solid layer around the core. The consistency of the solution depends on the atmospheric ambient conditions of temperature, humidity and barometric pressure. These conditions also affect whether the solvent is removed completely during each revolution of the core on the mandrel. The solvent, which is volatile, must be completely removed prior to the next step, which is subjecting the precursor layer to heat that is sufficient (100 to 130 degrees centigrade) to cure the rubber. The generation of the precursor layer using the knife coating technology takes on the order of two to three hours for a typical sleeve or cylinder.

Once this preliminary thickness of the precursor layer has been attained, the nitrile rubber forming the precursor layer must be cured by the application of heat and pressure in another time-consuming process that requires operator manipulation of the cylinder. First, a tape that shrinks when subjected to curing temperatures (noted above) is wound around the precursor layer. The taped sleeve may be placed into an oven and maintained at curing temperatures (noted above) for two to three days. As the tape shrinks, the necessary pressure is applied to the precursor layer in order to effect curing of the nitrile rubber. Once the curing step is done, the cylinder must be manipulated to another station where the surface of the precursor layer can be ground down to the desired thickness (typically three tenths to seven tenths of a millimeter) of the compressible layer forming a tubular body.

Reinforcement structures such as threads or meshes (of cotton or other material) can be built on top of the compressible layer. The reinforcement layer can be defined by an elastomeric matrix containing threads, preferably of cotton. The threads can be continuous or discontinuous. These reinforcement structures can be applied spirally or linearly on the compressible layer. The function of this reinforcement layer is to form a support structure with physical and mechanical characteristics that are far superior to those of the elastomeric nitrile rubber matrix that forms the compressible layer and the outer printing layer (now to be described).

Finally, the surface printing layer is formed of elastomeric material (nitrile rubber) on top of the tubular body with the reinforced structure. The surface printing layer can be formed like the compressible layer, except without the use of microspheres and the voids created thereby. Alternatively, the surface printing layer can be formed by another technology such as by extrusion of a natural rubber sleeve onto and around the reinforcing layer. The final surface of the outer printing layer is continuous and without joints. All of the layers of the known sleeve are all bonded together to form a single body. However, the required operator involvement and manipulation steps in the production process required to fabricate the known blanket sleeve prevent significant automation of this fabrication process. The low level of automation adversely affects the consistency of the sleeve that can be produced.

The consistency of the compressible layer is important for printing quality, and end users of the blanket sleeves are specifying acceptable ranges for compressibility. Indeed, the rampant inconsistency of the blanket sleeves has led many end users of the sleeves to test newly acquired sleeves and grade them A, B or C according to the degree of compressibility and assign them accordingly for various types of printing jobs. Moreover, the compressibility must stay within the specified range over time. However, the consistency of the compressible layer obtainable in the known rubber blanket sleeves is limited by the high degree of operator involvement and judgment during the fabrication process as well as by the unpredictable ambient conditions under which different sleeves are made for the same end-user. Moreover, residual solvent in the compressible layer will continue to create voids in the compressible layer and thus changes the compressibility of the overall sleeve over time. Residual solvent is a consequence of the fabrication process of the known rubber blanket sleeves. Thus, while a known rubber blanket sleeve may be delivered to the end-user with an acceptable compressibility, the compressibility of that sleeve may change enough over time to become outside the acceptable range.

Additionally, the aforesaid known blanket cylinder presents an outer layer of natural rubber or elastomeric material with inferior physical and mechanical characteristics, equivalent to those of rubber. The outer layer has poor mechanical strength, at least partly because of these characteristics of natural rubber. Consequently, the outer layer undergoes considerable wear during use. This wear is caused by the action on this outer layer of the blanket sleeve by the metal plate of the plate cylinder or by the edges of the substrate being printed, or by poor resistance to the wash solvents used in the printing process. A fold or other thickness variation in the substrate can irreversibly damage the surface of the outer layer and render the entire cylinder useless.

Moreover, the recurring pressure applied to the printing surface during repeated printing on the press eventually overcomes the outer layer's reboundability, i.e., its ability to resist permanent compression. Once the original thickness of this outer printing layer is diminished, the blanket sleeve becomes incapable of transferring the inked data to the substrate with the desired resolution of the printed image. This is particularly a problem in presses that print on both sides of the substrate and thus have a blanket cylinder on each side of the substrate, thus potentially doubling the problem as a bad image on one side of the substrate renders the entire substrate useless.

Furthermore, when the sleeve has a thin nickel core, the sleeve can become irreversibly damaged because the thin nickel core tends to kink during mounting and dismounting of the sleeve onto the rotary mandrel of the offset printing machine. These factors combine to curtail the “useful life” or duration of a blanket sleeve of the aforesaid known type. This curtailment presents obvious drawbacks from an economical viewpoint, especially in the cost of employing an offset printing machine that requires a plurality of blanket cylinders.

Commonly owned U.S. Pat. No. 6,688,226, which hereby is incorporated herein in its entirety for all purposes by this reference, disclosed blanket sleeve technology that overcame these problems with a three layer blanket sleeve that employed polyurethane material for the compressible layer instead of the nitrile rubber found in conventional blanket sleeves. This blanket sleeve also used polyurethane to form the incompressible blanket layer instead of the nitrile rubber found in conventional blanket sleeves. In some embodiments of this blanket sleeve, a fourth layer in the form of a reinforcing layer was interposed between the compressible layer and the incompressible blanket layer.

To make this improved blanket sleeve included starting with a cylindrical body to define the inner cylindrical portion of the blanket sleeve. The cylindrical body was composed of nickel, or a metal wire mesh or resin embedded with fiber such as fiberglass, carbon fiber, or aramid fiber.

Then a first pasty polyurethane material was deposited on the outer surface of the inner cylindrical portion. The first pasty polyurethane material is preferably elastomeric such as a polyether polyurethane or polyester polyurethane. The first pasty polyurethane material can be obtained by mixing a polyol and microspheres having a shell of a phenolic type of thermosetting resin surrounding a gas like isobutane or by mixing a polyol and swelling agents that release gas when heated or by mixing a polyol and water-soluble salts such as sodium chloride, magnesium chloride or magnesium sulphate. Ribbon technology was desirably used for depositing the first pasty polyurethane material on the outer surface of the inner cylindrical portion.

Then the first pasty polyurethane material was caused to solidify on the outer surface of the inner cylindrical portion to define the compressible layer of the sleeve. Causing the first pasty polyurethane material to solidify on the outer surface of the inner cylindrical portion was desirably accomplished by cross-linking the first polyurethane material at ambient pressure. This cross-linking could be allowed to proceed for about five hours if carried out at ambient temperature or could be accelerated by the addition of heat and/or cross-linking agents. Then the compressible layer was ground to the desired thickness and uniform surface.

Then at least one blanket layer was formed on the compressible layer, and the blanket layer so formed included polyurethane material carried by the cylindrical body and defining a printing surface for receiving the inked data to be transferred to the substrate. The incompressible blanket layer was formed of a second pasty polyurethane material that is preferably elastomeric such as a polyether polyurethane or polyester polyurethane. The blanket layer was formed by ribbon technology or by extrusion technology for example. If formed by ribbon technology, cross-linking could occur at ambient pressure. Cross-linking also could occur at ambient temperature or could be accelerated by the addition of heat and/or cross-linking agents. The incompressible blanket layer was ground to the desired thickness and uniform surface.

Alternatively, if a blanket sleeve with a fourth layer was desired, then the method could include forming the incompressible blanket layer on a reinforcing layer that is formed around the compressible layer. The reinforcing layer could be formed in any conventional way.

### OBJECTS AND SUMMARY

An object of the present invention is therefore to provide a blanket cylinder and/or blanket sleeve having superior physical and mechanical characteristics than known cylinders and/or sleeves such as to offer higher wear resistance, better reboundability, and greater resistance to creases in the surface and hence prolong the useful life of the product. The blanket sleeve should be able to be removably coupled to the rotary member or support (mandrel) of the offset printing machine to form a portion of the blanket cylinder.

Still another principal object is to provide a blanket sleeve having a single polyurethane layer that is so consistent in regards to compressibility and surface tension that the sleeve does not need to be individually categorized like current blanket sleeves.

A further object is to provide a blanket sleeve of the stated type having a lower cost than known sleeves for known blanket cylinders.

A still further object of the invention is to provide a method whereby a blanket sleeve of the stated type can be produced in a shorter time than conventional sleeves.

A yet further object of the invention is to provide a method whereby a consistent blanket sleeve of the stated type can be produced regardless of ambient conditions and personnel available during production.

Another object of the invention is to provide a method whereby a blanket sleeve of the stated type can be produced by procedures that are more automated than the procedures for making conventional sleeves.

Additional objects and advantages of the invention will be set forth in part in the description that follows, and in part will be obvious from the description, or may be learned by practice of the invention. The objects and advantages of the invention may be realized and attained by means of the instrumentalities and combinations particularly pointed out in the appended claims. To achieve the objects and in accordance with the purpose of the invention, as embodied and broadly described herein, a blanket sleeve and blanket cylinder and method for making each of them now will be described in summary fashion with reference to the blanket sleeve.

The sleeve comprises an inner cylindrical portion configured to be drawn over the aforesaid rotary support. The outer surface of the inner cylindrical portion is covered by a single layer structure that cooperates directly with the lithographic plate and with the substrate to be printed. The single layer structure consists essentially of polyurethane material and microspheres, which are uniformly dispersed throughout the single layer. The microspheres constitute no less than about 0.6 percent by weight and no more than about 4.4 percent by weight of the single layer. The single layer is formed of a precursor that is deposited by ribbon technology onto the outer surface of the inner cylindrical portion. The precursor consists essentially of three main components, namely, polyol, curing agent and microspheres. For every about 100 grams of polyol in the precursor material, there are from about 30 grams to about 60 grams of the curing agent and from about one gram to about six grams of the microspheres. Thus, in the precursor material the microspheres constitute between about 1 percent by weight of the polyol component and about 6 percent by weight of the polyol component. The curing agent for the polyol is provided such that the weight ratio of the polyol to the curing agent is in the range of about 100:30 to about 100:60. In one presently preferred example, for every 100 grams of polyol in the precursor material, the microspheres constitute 1.8 grams in the precursor material, and the curing agent constitutes 50 grams in the precursor material.

As embodied and broadly described herein, the improved method of making the improved blanket sleeve includes providing a cylindrical body to define the inner cylindrical portion of the blanket sleeve. The cylindrical body that defines the inner cylindrical portion of the blanket sleeve desirably is composed of nickel, or a metal wire mesh or resin embedded with fiber such as fiberglass, carbon fiber, or aramid fiber. The cylindrical body that defines the inner cylindrical portion of the blanket sleeve also can be provided by a steel cylinder or an aluminum tube or an aluminum clad sleeve.

The method desirably includes forming the one layer on the inner cylindrical portion by depositing on the outer surface of the inner cylindrical portion a runny polyurethane precursor material containing proportionately by weight: 100 parts polyol, about 30 parts to about 60 parts isocyanate, about 1 part to about 6 parts non-expanding microspheres and about 3 parts thixotropic agent. The density of the runny polyurethane precursor material is desirably in a range of between about 0.6 kg/dm³ and about 0.8 kg/dm³ and desirably is about 0.7 kg/dm³. The polyol is preferably elastomeric such as a polyether polyurethane or a polyester polyurethane.

However, desirably, for each 100 grams of polyol in the precursor material there are between about 1 gram of microspheres to about 3 grams of microspheres. Desirably, for each 100 grams of polyol in the precursor material there are between about 1 gram of microspheres to about 2 grams of microspheres. Desirably, in one example, for each 100 grams of polyol in the precursor material there are 1.5 grams of microspheres. Desirably, in a presently preferred example, for each 100 grams of polyol in the precursor material, there are 1.8 grams of microspheres in the precursor material.

Additionally, the weight proportion of isocyanate can be varied from 50 parts for every 100 parts of polyol to proportionately vary the Shore A hardness of the finished single outer layer of the blanket sleeve such that each part above or below 50 parts will translate roughly into 3 or 4 points above or below, respectively, in the Shore A hardness of the finished single outer layer of the blanket sleeve.

Ribbon flow technology is desirably used for depositing the runny polyurethane precursor material on the outer surface of the inner cylindrical portion. Desirably, the inner cylindrical portion is mounted on a cylindrical mandrel of a ribbon flow technology dispensing system. The polyol containing the desired percent by weight of microspheres can be provided to the mixing head of the ribbon flow technology dispensing system and can be combined with a curing agent (isocyanate) in the mixing head before being dispensed from a nozzle immediately downstream of the mixing head and onto the outer surface of the inner cylindrical portion in ribbons that helically wind around the cylindrical portion as the mandrel rotates. As the mandrel rotates, the nozzle can be moved axially to make successive passes back and forth over the length of the precursor sleeve. With each pass down the length of the cylindrical portion, the nozzle deposits a continuous ribbon of the runny polyurethane precursor material around the precursor sleeve until a desired radial thickness of the polyurethane precursor material is attained. Typically, only a single pass down the length of the cylindrical portion will suffice, and this single pass can be completed in about ten minutes for a typical blanket sleeve. Then the polyurethane precursor material is allowed to cure to solidify to form a single solid polyurethane layer on the inner cylindrical portion.

Causing the runny polyurethane precursor material to solidify to form a single polyurethane layer on the outer surface of the inner cylindrical portion is desirably accomplished by cross-linking the runny polyurethane precursor material at ambient pressure and temperature. This cross-linking can be allowed to proceed for about twenty-four hours to about forty-eight hours if carried out at ambient temperature and pressure or can be accelerated by the addition of heat and/or cross-linking agents. The density of the cured single polyurethane layer is desirably in a range of between about 0.6 kg/dm³ and about 0.8 kg/dm³ and desirably is about 0.7 kg/dm³.

After the single polyurethane layer has cured into a solid layer, then the exterior surface of the single polyurethane layer is ground to a uniform parallel surface on the exterior surface of a solid polyurethane layer of the desired radial thickness above the inner cylindrical core. The parallel exterior surface can be finished by being polished, which can be accomplished by machine or manually.

The result is a blanket sleeve that employs only one layer that desirably is composed of polyurethane containing evenly dispersed microspheres, which taken together occupy from about 0.6 percent by weight to about 4.4 percent by weight of the single, solid polyurethane layer, and that functions to provide adequate compressibility as found in conventional blanket sleeves and adequate incompressibility as required in conventional blanket sleeves and without any reinforcing layer. The single, solid polyurethane layer extends over the inner cylindrical body and has a density that desirably is between about 0.6 kg/dm³ and about 0.8 kg/dm³ and desirably is about 0.7 kg/dm³. The exterior surface (printing surface) of the single, solid polyurethane layer of the blanket sleeve desirably has a hardness of between about 50° Shore A and about 75° Shore A, and desirably between about 55° Shore A and about 65° Shore A, and desirably between about 58° Shore A and about 62° Shore A, and desirably is about 60° Shore A. The finished outer diameter of the single, solid polyurethane layer of the blanket sleeve has a tolerance of plus 0.02 mm and minus 0.01 mm. The total indicated runout (TIR, indicative of the degree to which the surface is out of round) of the finished outer surface of the single, solid polyurethane layer of the blanket sleeve is a maximum of 0.02 mm. Though the finished exterior surface of the single, solid polyurethane layer of the finished sleeve has tiny pores where the microspheres have released from the surface, as long as the weight of microspheres per 100 grams of polyol in the precursor material is kept within the critical range of not less than about one gram and not greater than about six grams, then the surface tension of the exterior surface of the finished blanket sleeve is conducive to releasing the ink to the substrate when the sleeve is in use on the printing machine.

Similarly, a blanket cylinder can be provided that employs only one blanket layer that is identical to the single, solid polyurethane layer described above for the blanket sleeve. The one layer can be formed on an inner cylindrical body composed of nickel, or a metal wire mesh or resin embedded with fiber such as fiberglass, carbon fiber, or aramid fiber. The inner cylindrical body alternatively can be provided by a steel cylinder or an aluminum tube or an aluminum clad sleeve.

An offset machine can be provided with blanket cylinders covered with the single polyurethane layer described above or can be provided with mandrels on which can be mounted blanket sleeves covered with the single polyurethane layer described above.

### BRIEF DESCRIPTION OF THE DRAWINGS

The invention will be more apparent from the accompanying drawings, which is provided by way of non-limiting example and in which:

FIG. 1 schematically represents a perspective view of a blanket cylinder presenting a presently preferred embodiment of a sleeve obtained in accordance with the invention, mounted on an independent rotary mandrel;

FIG. 2 schematically shows a block diagram of a presently preferred embodiment of a method for obtaining a sleeve in accordance with the invention;

FIG. 3A schematically represents an enlarged partial detail view, shown partially in perspective and partially in cross-section, of a section of the sleeve shown in FIG. 1 and designated by the arrows 3-3;

FIG. 3B schematically represents an enlarged partial cross-sectional view on the line 3-3 of FIG. 1; and

FIG. 4 schematically represents a perspective view of an alternative embodiment of the invention showing a blanket cylinder presenting a rotary portion clad directly with a sleeve that is integral with the rotary portion.

FIG. 5 schematically represents an offset machine provided with at least one blanket cylinder and/or a blanket sleeve that is mounted integrally on a blanket mandrel.

Repeat use of references characters in the present specification and drawings is intended to represent same or analogous features or elements of the invention.

### DETAILED DESCRIPTION OF THE PREFERRED EMBODIMENTS

Reference now will be made in detail to at least the presently preferred embodiments of the invention, one or more examples of which being set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations and their equivalents.

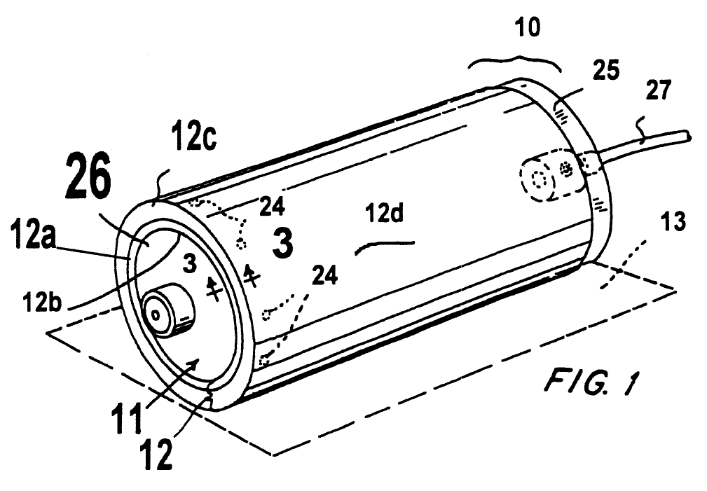

With reference to FIG. 1, a blanket cylinder for an offset printing machine is indicated overall by the numeral 10 and comprises a rotary support or mandrel 11 over which a layered sleeve 12 can be drawn. The mandrel/sleeve system can be either of two types. In one type, the inner diameter of the sleeve 12 remains fixed, and the outer diameter of the mandrel 11 expands and contracts (usually with the aid of an hydraulic system) to permit mounting and dismounting of the sleeve 12 to the mandrel 11. In another type, the outer diameter of the mandrel 11 remains fixed, and the inner diameter of the sleeve 12 expands and contracts (usually with the aid of a compressed air system) to permit mounting and dismounting of the sleeve 12 to the mandrel 11.

As an example of the latter type, the mandrel 11 shown in FIG. 1 is of known type provided with internal ducts (not shown) that extend axially and open at 24 onto a free surface 25 of the mandrel at one end 26 of the mandrel 11. A pipe 27 connected to the mandrel 11 supplies compressed air through the openings 24 via these ducts and thus carries pressurized air onto the surface 25 of the mandrel 11. By virtue of this pressurized air that provides enough force to slightly, radially deform the inner hollow surface of the blanket sleeve 12, the blanket sleeve 12 can be drawn over the outer cylindrical surface 25 of the mandrel 11 as a person's sock is drawn over the person's foot.

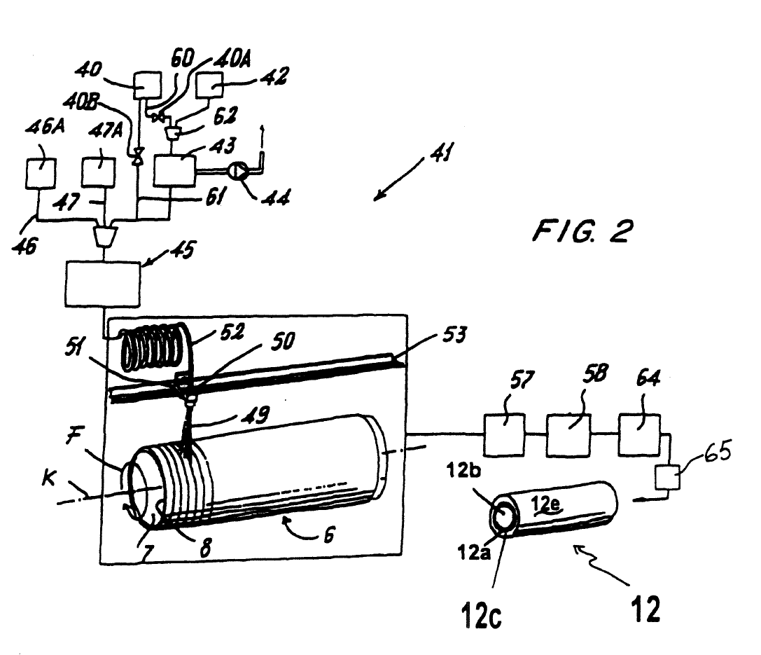

As shown in FIGS. 1 and 2, the blanket sleeve 12 comprises an inner tubular cylindrical portion 12a arranged to cooperate directly with the outer surface 25 of the mandrel 11. In particular, as shown in FIG. 2 for example, the cylindrical portion 12a has a through longitudinal bore that presents a cylindrically shaped inner surface 12b configured to cooperate with the mandrel's cylindrical outer surface 25 (FIG. 1).

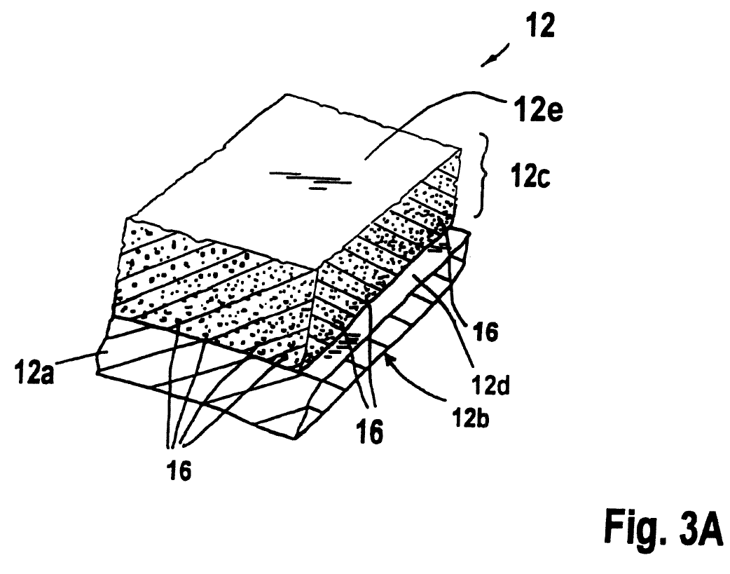

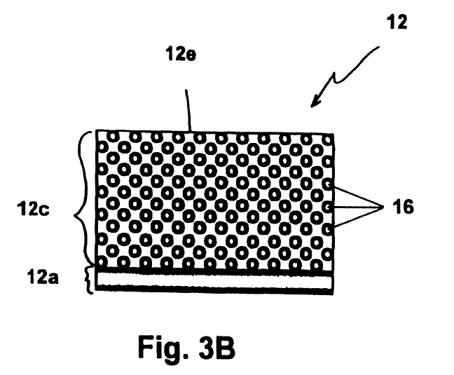

As schematically shown in the partially cut-away view of FIG. 3A for example, a single layer 12c is formed and permanently attached to the outer surface 12d of the inner cylindrical core 12a. As schematically shown in FIG. 3B for example, the single layer 12c is composed of material that has an essentially uniform density over the radial thickness and circumferential dimension of the single layer 12c. The single layer 12c is composed of material that has an essentially uniform density over the axial length of the single layer 12c.

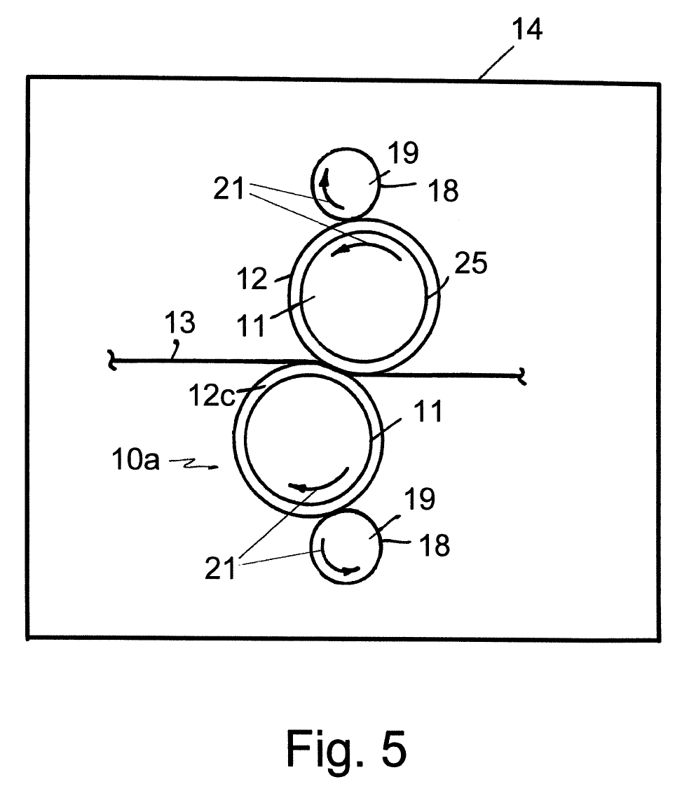

As shown in FIGS. 1 and 3A for example, the outer surface 12e of single layer 12c is the outermost surface of the blanket sleeve 12 and thus the surface that receives the ink (or other medium to be transferred) and transfers the ink to the substrate 13 (shown in dashed outline in FIG. 1) or other receiving surface. This outer surface 12e of the single layer 12c is configured to cooperate directly with a lithographic plate (e.g., 18 in FIG. 5) carried by another cylinder (e.g., printing cylinder 19 in FIG. 5) of the printing machine 14 (FIG. 5), and with a substrate 13 (FIGS. 1 and 5), for example a web of paper or plastic, on which the printing is to be applied.

In embodiments requiring the cylindrical portion 12a to expand in order to be mounted on the rotary mandrel 11, the material forming the cylindrical portion 12a cannot be so thick that it is rendered unable to expand sufficiently to be mounted on the mandrel 11 when the compressed air is applied to the elastic cylindrical portion 12a through the openings 24. Compressed air desirably is provided in a range of about 6 bar to about 8 bar and more desirably about 6 bar is provided. The elasticity of the cylindrical portion 12a that forms the inner core of the blanket sleeve 12 can be related to the radial thickness of the cylindrical portion 12a, which can have a radial thickness between about 0.1 mm and about 2.0 mm when intended to be expandable and depending on the material used for its construction.

More particularly, when intended for mounting on a rotary mandrel 11 of fixed diameter, the inner cylindrical portion 12a (aka inner core 12a) is constructed of material sufficiently elastic to enable the cylindrical portion 12a itself to elastically expand radially by a minimum amount to enable it to be mounted on the mandrel 11. If the cylindrical portion 12a is constructed of a thin cylindrical shell formed of nickel, then the cylindrical portion 12a desirably should have a radial thickness in a range of about 0.1 mm to about 0.5 mm and desirably in a range of between about 0.1 mm and about 0.25 mm. The radial thickness of the nickel shell 12a desirably can be in a range of about 0.127 mm to about 0.228 mm and desirably is about 0.178 mm.

However, the cylindrical portion 12a alternatively can have a composite structure of resins and fiber glass. Examples of compositions that are suitable for composing the cylindrical portion 12a include one of the group consisting of aramid fiber bonded with epoxy resin or polyester resin, and reinforced polymeric material such as hardened glass fiber bonded with epoxy resin or polyester resin, the latter two also known as fiberglass reinforced epoxy resin or fiberglass reinforced polyester. If the cylindrical portion 12a is constructed of a thin cylindrical shell formed of resins and fiber glass, then the cylindrical portion 12a desirably should have a radial thickness desirably in a range of about 0.3 mm to about 1.0 mm and particularly in a range of about 0.5 mm to about 0.8 mm. A radial thickness of about 0.5 mm seems to work well for a cylindrical portion 12a formed of resins and fiber glass for sleeves 12 that are to be used on Heidelberg offset printing machines. A radial thickness of about 0.8 mm seems to work well for a cylindrical portion 12a formed of resins and fiber glass for sleeves 12 that are to be used on MAN Roland offset printing machines.

Alternatively, when intended for mounting on a rotary mandrel of changeable diameter, the cylindrical portion 12a desirably is constructed of material sufficiently inelastic to enable the cylindrical portion 12a to retain a fixed diameter under pressure from the expanding mandrel. In this case, the cylindrical portion 12a desirably is constructed of a composite structure of graphite impregnated plastics or of resins and fibers such as carbon fibers. In the latter, the carbon fiber is desirably oriented parallel to the rotational axis K (FIG. 2) in order to provide the inner core 12a with maximum rigidity. The cylindrical portion 12a also can be constructed of a strip of metal or rigid polyurethane with a hardness exceeding 70° Shore D. The cylindrical body that defines the inner cylindrical portion 12a of the blanket sleeve 12 also can be provided by a steel cylinder or an aluminum tube or an aluminum clad sleeve.

According to the presently preferred embodiments of the invention and as shown in FIG. 3A for example, the single layer 12c carried by the inner cylindrical portion 12a desirably is formed of polyurethane material. However, this single layer 12c is processed in a manner that results in a density that is less than the density of polyurethane alone. Incidentally, the relative radial thicknesses of the single layer 12c and the inner cylindrical portion 12a are not drawn to scale in FIG. 3A, as this drawing is for illustrative purposes and is not intended as an engineering drawing.

The polyurethane material for the single layer 12c is preferably elastomeric and based on polyether or polyester. The choice between polyether and polyester may depend on what sorts of inks and solvents are likely to be encountered in the work environment. Polyester resists degradation in environments where alcohol is likely to be encountered. Polyether resists degradation in environments where acetates and acetone are likely to be encountered. It also might be possible to use polyurethane material based on hydroxyl-terminated polybutadienes to form the single layer 12c.

More particularly, the single layer 12c desirably is configured in a cylindrically shaped shell and disposed around the outer surface 12d of the inner core 12a. The single layer 12c desirably is formed with open cells or closed cells. As shown in FIG. 3 for example, the single layer 12c must be formed of polyurethane of cellular structure with internal cells or lower density regions 16 or cells 16 that desirably can be obtained by inserting into the polyurethane material a plurality of non-expanding microspheres, which thus become encapsulated within the single layer 12c when the polyurethane material sets or cures. These microspheres are available from Expancel of Stockviksverken, Sweden, a subsidiary of Akzo Nobel, and sold under the Expancel® trade name. These microspheres comprise, for example, an outer skin mainly consisting of a copolymer of vinylidene chloride, acrylonitrile and/or methacrylate, or other similar thermoplastic resins. As used herein, a copolymer includes repeating units composed of two or more monomers. The outer skin also can be obtained from a thermosetting resin (e.g., of phenolic type). These microspheres desirably contain gaseous isobutene confined within the outer skin.

Alternatively, the aforesaid lower density regions 16 or cells 16 can be obtained by mixing the polyurethane with swelling agents followed by expansion. These agents are known per se (such as that known commercially as POROFOR available from Bayer AG, the well known manufacturer of chemicals headquartered in Germany) and develop nitrogen or other gases when heated. The developed gas expands to create the lower density regions 16 or cells 16 within the single layer 12c. The heat for this gaseous expansion desirably is provided by the exothermic reaction that occurs as the polyurethane material sets or cures.

In a further variant, the cells 16 can be obtained by mixing the polyurethane material with water-soluble salts such as sodium chloride or magnesium chloride or magnesium sulphate. The particles of these salts dispersed homogeneously within the polyurethane material are then removed by water, to generate a so-called “open cell” structure.

As shown in FIG. 3A for example, the printing surface 12e is formed of the outermost cylindrically shaped exterior surface of the single layer 12c and thus is also composed of polyurethane. The cells 16 that interrupt the printing surface 12e become pores 16 that are so small as to be undetectable by the naked eye. The diameters of the cells 16 are in the same range as the diameters of the microspheres, namely, about 40 microns to about 80 microns. The single polyurethane layer 12c has a desired density of about 0.7 kg/dm³. This density of the single layer 12c is desirably in a range of between about 0.6 kg/dm³ and 0.8 kg/dm³. The exterior surface 12e of the single layer 12c (printing surface) desirably has a hardness of between about 50° Shore A and about 75° Shore A, and more desirably between about 55° Shore A and about 65° Shore A, and more desirably between about 58° Shore A and about 62° Shore A, even more desirably about 60° Shore A. The exterior surface 12e of the single layer 12c (printing surface) desirably has good resistance to wash solvents. The exterior surface 12e of the single layer 12c (printing surface) desirably has an ultimate elongation in a range of about 110% to about 130% calculated by mechanical test at break. In practical terms, one can squeeze the sleeve 12 between one's thumb and forefinger and feel the sleeve 12 compress and spring back without any residual deformation of the printing surface 12e of the sleeve 12.

The embodiment of the blanket sleeve 12 described above is of the type that is independent of the mandrel 11. The typical dimensions of a finished sleeve 12 has an internal diameter of the cylindrically shaped inner surface 12b on the order of about 15 cm to about 20 cm. A typical finished sleeve 12 might have an axial length of about 150 cm to about 210 cm. The radial thickness of a typical embodiment of sleeve 12, including the core 12a and the single layer 12c, would measure in a range of about 1.5 mm about to about 2.5 mm. The ideal radial thickness of the sleeve is believed to be somewhat dependent on the source of the offset printing machine on which the sleeve 12 is to be used. For example, a typical radial thickness of a sleeve 12 that is to be used on a Heidelberg offset printing machine is about 1.5 mm, while a typical radial thickness of a sleeve 12 that is to be used on a MAN Roland offset printing machine is about 2.0 mm. As noted above, a typical radial thickness of a core 12a made of nickel is about 0.5 mm, and accordingly a thickness of about 1 mm to about 2 mm for the single layer 12c would be typical for such a sleeve 12 having a radial thickness of about 1.5 mm to about 2.5 mm. These dimensions are not meant to limit the dimensions of the sleeves 12 but are merely provided as examples of dimensions that are can be found in sleeves currently being used in the industry. With such dimensions, the blanket sleeve 12 can be transported easily (by virtue of its relatively light weight in comparison to a mandrel 11) and can be drawn over the mandrel 11 to form the cylinder 10.

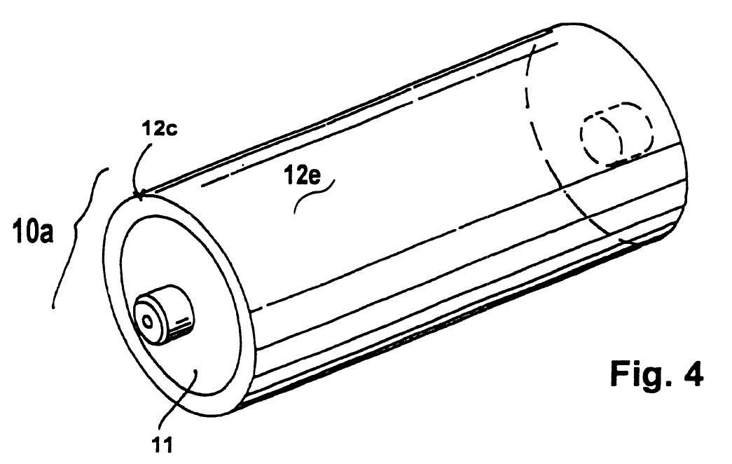

FIG. 5 schematically illustrates a printing machine 14 with particular emphasis on a blanket cylinder 10a and a blanket mandrel 11 shown in relation to a printing cylinder 19 having a lithographic plate 18. The arrows designated 21 schematically indicate the direction of rotation of the mandrel 11 and blanket cylinder 10a during printing operation of the machine 14. Though it would be unusual for such a pair to be employed to print on opposite sides of a substrate 13, they are so presented in FIG. 5 for purposes of illustrating the two types of configurations employing the inventive single layer blanket 12c. As shown in FIGS. 1 and 5 for example, a blanket sleeve 12 can become an integral part of the mandrel 11 when sleeve 12 becomes stably locked to the surface 25 of the mandrel 11. In this case, the inner cylindrical portion 12a described in relation to FIG. 1 non-rotatably mates with the mandrel 11. Alternatively, the single layer 12c shown in FIGS. 3 and 5 can be formed directly on and thus carried by the mandrel 11 to form the blanket cylinder 10a shown in FIGS. 4 and 5 for example. In this latter case, the outer surface of the mandrel 11 takes the place of the outer surface 12d of the inner core 12a of sleeve 12.

In each case, in accordance with the present invention, when the precursor material is desirably 100 grams by weight polyol and 50 grams by weight cross-linking agent (isocyanate), as the amount of microspheres can vary between 1 gram and 6 grams, then the single layer 12c that desirably is formed by a cylindrical annulus formed of solid polyurethane has tiny cells 16 uniformly dispersed throughout such polyurethane, and those cells 16 constitute no less than about 0.65 percent by weight and no more than about 3.9 percent by weight of the single layer 12c. Desirably, the weight of the microspheres that occupy the cells 16 in the single layer 12c is from about one percent by weight to about three percent by weight. Desirably, the weight of the microspheres that occupy the cells 16 in the single layer 12c is from about one percent by weight to about two percent by weight. Desirably the weight proportions in the single layer 12c are about one and one-half percent microspheres and about ninety-eight and one-half percent polyurethane. Desirably the single layer 12c has about 1.2 percent microspheres by weight and about 98.8 percent polyurethane by weight.

The sizes of the cells 16 are on the order of the sizes of the non-expanding microspheres that are used to generate the cells 16. As such as noted above, the cells 16 in the printing surface 12e have diameters averaging in the range of about 40 microns to about 80 microns and thus cannot be detected by the naked eye. Such a single layer 12c provides surface tension that releases the ink and yet provides enough dimensional stability and compressibility for offset printing. Moreover, because of the unique single layer 12c, it has been found that the commercially useful life of a sleeve 12 or cylinder 10a of the present invention is on the order of six to ten times longer than the commercially useful life of a conventional rubber blanket.

The production of an embodiment of blanket sleeve 12 of the type that can be drawn over a rotary mandrel 11, now will be described with reference initially to FIG. 2.

In producing the blanket sleeve 12, a cylindrical body is provided to define the inner cylindrical portion 12a (aka core) of the blanket sleeve 12. The inner cylindrical portion 12a is obtained by methods that are known per se and therefore not described. Reference is made for example to commonly owned U.S. Pat. No. 7,308,854, which is hereby incorporated herein in its entirety for all purposes by this reference. Moreover, the production of the inner cylindrical portion 12a can be at least largely automatic and independently precede the production of the rest of the blanket sleeve 12.

When fully mixed together and ready to be dispensed as a runny polyurethane precursor material, the runny polyurethane precursor material desirably will consist essentially of by weight proportions: about 100 parts polyol, about 50 parts isocyanate (curing agent), about 1.8 parts microspheres and about 3 parts thixotropic agent. The density of the runny polyurethane precursor material is desirably in a range of between about 0.6 kg/dm³ and about 0.8 kg/dm³ and desirably is about 0.7 kg/dm³. The polyol is preferably elastomeric such as a polyether polyurethane or a polyester polyurethane. These polyols are available from Bayer AG of Germany and from Chemtura Corporation of Middlebury, Conn. (formerly Uniroyal Chemical Corporation). It also might be possible to use hydroxyl-terminated polybutadienes as a polyol precursor material to form the single layer 12c.

The isocyanate is available from Dow Chemical Company of Midland, Mich. Additionally, the weight proportion of isocyanate can be varied from the 50 parts to proportionately vary the Shore A hardness of the finished single outer layer of the blanket sleeve such that each part above or below 50 parts will translate roughly into 3 or 4 points above or below, respectively, in the Shore A hardness of the finished single outer layer 12c of the blanket sleeve 12.

As schematically shown in FIG. 2, simultaneously (or previously) with the fabrication of the inner cylindrical portion 12a, a first tank 40 of a plant 41 can be filled with the polyol used for preparing the polyurethane precursor material to obtain the single layer 12c. Some examples of suitable polyols also can be found in U.S. Pat. No. 5,648,447, which is hereby incorporated herein in its entirety for all purposes by this reference. First tank 40 can be provided with a mixture of the polyol already combined with the suitable portion of the thixotropic agent. Moreover, as explained below, first tank 40 can be provided with a mixture of the polyol already combined with the suitable portion of the thixotropic agent and the desired proportion by weight of microspheres. Such a mixture of the polyol already combined with the suitable portion of the thixotropic agent and the desired proportion by weight of microspheres is available from the Rampf Group of Germany, which has a subsidiary in Wixom, Mich. Desirably, the weight of microspheres in the polyol portion is from about one percent by weight to about six percent by weight. Desirably, the weight of microspheres in the polyol portion is from about one percent by weight to about three percent by weight. Desirably, the weight of microspheres in the polyol portion is from about one percent by weight to about two percent by weight. Desirably the weight proportions are about 1.8 percent (1.8%) microspheres and about 98.2 percent (98.5%) polyol.

As schematically shown in FIG. 2, a first tank 40 is connected to a first mixer head 62 via a line 60. A valve 40A in line 60 can be opened or closed to control whether any flow occurs through line 60 from first tank 40 to first mixer head 62. A line 61 also leads from first tank 40 and has a valve 40B that can be opened or closed to control whether any flow occurs through line 61 from first tank 40. A suitable quantity of microspheres can be fed into a second tank 42, which is also connected by another line to first mixer head 62. Yet another line connects first mixer head 62 to a mixing chamber 43, which can be placed under vacuum by a vacuum pump 44. Without the vacuum, the microspheres are so small (diameters averaging in the range of about 40 microns to about 80 microns) and light in weight that they would not otherwise flow solely under the influence of gravity. The density of the microspheres is about 0.03 kg/dm³. The operation of the first mixer head 62, the valves 40A, 40B and pump 44 can be controlled automatically and remotely as by computerized process controls for example.

In one embodiment of the process, valve 40B is closed and valve 40A is opened. The polyol product (with thixotropic agent) contained in first tank 40 and the microspheres contained in second tank 42 are fed into first mixer head 62. The mixed product of polyol and microspheres leaving first mixer head 62 is drawn into mixing chamber 43 by vacuum pump 44. The desired quantity of microspheres that is fed into mixing chamber 43 is such that it generally becomes the desired proportion by weight of the polyol precursor material. Desirably, for every 100 grams of polyol, the weight of microspheres in the polyol portion is from about one gram to about six grams. Desirably, for every 100 grams of polyol, the weight of microspheres in the polyol portion is from about one gram to about three grams. Desirably, for every 100 grams of polyol, the weight of microspheres in the polyol portion is from about one gram to about two grams. Desirably, for every 100 grams of polyol, the weight of microspheres is about 1.8 grams. It is critical that for every 100 grams of polyol, the microspheres must constitute no less than about one gram and no more than about six grams in mixing chamber 43. The weight proportion of microspheres can be varied within this range of about one gram to about six grams in order to vary the compressibility of the final blanket sleeve that is desired.

Alternatively, valve 40A is closed and valve 40B is opened. The microspheres can be mixed with the polyol outside of the production cycle. In this alternative case, the base solution in first tank 40 comprises precursor material of polyol already mixed with microspheres so that the weight proportion of microspheres will be in a desired range of the weight proportion of the polyol. As noted above, such a mixture of the polyol already combined with the suitable portion of the thixotropic agent and the desired proportion by weight of microspheres can be obtained from the Rampf Group of Germany, which has a subsidiary in Wixom, Mich.

A mixing member 45 (or simply mixer) is basically a small chamber having a rotor for mixing and is provided with two basic components. One of the components is the above-noted precursor material of polyol mixed with microspheres, which is a runny product such that it will run off of a stick that is dipped into it. The above-noted precursor material of polyol mixed with microspheres that leaves the chamber 43 (or first tank 40 in the alternative embodiment) is fed into mixing member 45. This first component also can include other ingredients, as desired, such as pigments, fillers, diamines, and catalysts. The second component is primarily the cross-linking element (such as isocyanate), but can include a thixotropic agent (such as an amine) if not already supplied in the solution contained in first tank 40. The density and viscosity of the cross-linking element (such as isocyanate) are very close to the density and viscosity of the first component consisting of polyol mixed with microspheres. As shown schematically in FIG. 2, line 46 feeds into mixer 45 from tank 46A containing a cross-linking element. Diphenyl methane-4-4-diisocyanate (also known as MDI) is a suitable cross-linking element, which is readily available from Dow Chemical Company of Midland, Mich. Similarly, line 47 feeds into mixer 45 from tank 47A, which can contain a thixotropic cross-linking agent such as an amine.

The first component is the main component by weight provided to mixer 45. The ratio by weight of the first component (polyol mixed with microspheres) to the second component (combination of the cross-linking element and the thixotropic agent) is desirably in the range of about 70% to 30% to about 65% to 35% and desirably in the range of about 100:30 to 100:60 and desirably in a ratio of 100 parts by weight of the first component (polyol mixed with microspheres) to 52 parts by weight of the second component (combination of the cross-linking element and the thixotropic agent). The blanket sleeve's desired characteristics of hardness, resilience, reboundability, solvent resistance, and mechanical characteristics can be tailored by changing the chemical structure of the two components. The weight percentage of cells 16 in the final cured single polyurethane layer 12c of the sleeve 12 depends on the proportion of microspheres mixed with the polyol and the weight ratio of the first component (polyol mixed with microspheres) to the second component (combination of the cross-linking element and the thixotropic agent).

Note that the various components combine in the mixer 45 to form a runny product. As shown schematically in FIG. 2, the runny product 49 leaves the mixer 45 via a line 52 to be deposited on the outer surface 12d of the cylindrical portion 12a according to ribbon flow technology. During deposition, cylindrical portion 12a is rotated about its axis K as schematically shown by the arrow F in FIG. 2. The nozzle 50 and cylindrical portion 12a desirably are movable with respect to each other in traversing axial movements. As schematically shown in FIG. 2 for example, the nozzle 50 can be associated with a carriage 51 (to which a hose 52 is connected from the mixer 45) that is movable along a straight guide 53 arranged parallel to the axis K of the cylindrical portion 12a.

Desirably, the runny product is dispensed from nozzle 50 in the form of a continuous ribbon 49 as opposed to a spray that contains discontinuous droplets entrained in a gas. As shown schematically in FIG. 2, the runny product 49 can be fed via line 52 to a nozzle 50 that is configured to deposit a continuous ribbon of the runny product 49 directly onto the outer surface 12d of the cylindrical inner core 12a (or the outer surface 25 of the mandrel 11 in alternative embodiments). As the runny product 49 is applied onto the outer surface 12d of the cylindrical inner core 12a, the runny product 49 undergoes an exothermic chemical reaction and immediately begins formation of the cross-linked polyurethane layer 12c that adheres to the outer surface 12d of the cylindrical inner core 12a without the aid of adhesives, regardless of whether the inner core 12a is formed of a nickel shell or a core formed of a fiber embedded resin. Within a minute or two after being dispensed from the nozzle 50, the runny flowing ribbon 49 has solidified.

The runny product 49 leaving the mixer 45 is deposited in one or more passes on the surface of the cylindrical inner core 12a. Typically, a single pass of the nozzle 50 down the length of the cylindrical inner core 12a while the core 12a is rotating about its longitudinal axis is sufficient to form the single layer 12c. The rate at which the ribbon of the runny product 49 is dispensed from the nozzle desirably can be on the order of about 2.5 grams per second. Thus, in about 10 minutes, enough of the runny polyurethane material 49 can be dispensed in a single pass of the nozzle 50 down the length of the cylindrical inner core 12a to form an entire sleeve 12 measuring about 150 centimeters long and having a single polyurethane layer 12c with a radial thickness of about 2 millimeters.

On termination of deposition of the runny product 49, the solidified runny product 49 deposited on the cylindrical portion 12a is allowed to cool to room temperature. The cooling step can take anywhere from about 15 minutes to an hour or so and is indicated schematically by the block 57 of FIG. 2.

While the runny product 49 deposited on the cylindrical portion 12a sets and solidifies in about one minute or two minutes to the point where it no longer is flowable, it is desirable to let the single layer 12c cure (cross-link) for about 24 hours to about 48 hours before beginning to grind the surface to a parallel condition. This cross-linking or curing step can be carried out to form the cells 16 in the single layer 12c, and the curing step is indicated schematically by the block 58 of FIG. 2. For those microspheres partially exposed at the surface of the polyurethane layer 12c, the heat that is released during cross-linking can cause the outer skins of the microspheres to degrade and burst to create the pores 16 in the surface, which pores 16 remain after the heat dissipates.

The density of the cured single polyurethane layer 12c is desirably in a range of between about 0.6 kg/dm³ and about 0.8 kg/d m³ and desirably is about 0.7 kg/dm³. When the curing step has passed, the outermost surface 12e of the single layer 12c superposed on cylindrical portion 12a in this manner is parallel ground to the desired radial thickness. This grinding step is indicated schematically by the block 64 of FIG. 2. The purpose of this grinding is to achieve a parallel exterior surface 12e as well as to obtain a desired radial thickness of the exterior surface 12e of the single layer 12c.

After the grinding step performed on the single layer 12c, then the exterior surface 12e of single layer 12c desirably can be polished by machine or manually to an average metric surface roughness in a range of about 1.0 Ra micrometer to about 7.0 Ra micrometers and desirably in a range of about 3.0 Ra micrometers to about 5.0 Ra micrometers. If polished by machine, the exterior surface 12e of single layer 12c desirably can be felt polished. If polished manually, the exterior surface 12e of single layer 12c desirably can be polished manually using 800 grit sand paper. The block 65 of FIG. 2 schematically indicates the polishing step to thus obtain the final product in the form of sleeve 12 with exterior surface 12e.

The aforesaid method can be implemented automatically or largely automatically. However, it may be economically more desirable to effect the manual manipulation of the sleeve 12 rather than machine handling of the sleeve 12, for surface grinding of the outermost surface of the precursor single layer 12c.

The finished outer diameter of the blanket sleeve 12 has a tolerance of plus 0.02 mm and minus 0.01 mm. The total indicated runnout (TIR, indicative of the degree to which the surface is out of round) of the finished outer surface 12e of the blanket sleeve 12 is a maximum of 0.02 mm.

The single layer 12c is formed desirably with a hardness of about Shore A 60° and a density of about 0.7 kg/dm³. The density of the single layer 12c is desirably in a range of between about 0.6 kg/dm³ and about 0.8 kg/dm³. The exterior surface (printing surface) of the single polyurethane layer 12c of the blanket sleeve 12 desirably has a hardness of between about 50° Shore A and about 75° Shore A, and desirably between about 58° Shore A and about 62° Shore A. The single layer 12c has an elongation in the range of about 110% to 130% calculated by mechanical test at break and ideally in the range of about 120% to 125% calculated by mechanical test. Conceptually, the single layer 12c could be considered to be relatively hard enough to be supportive of the exterior surface 12e being resistant to unwanted distortion of the image being transferred. While the single layer 12c is composed of a relatively less compressible surface 12e, that surface 12e has pores 16 to compensate for the reduced compressibility, and therefore that surface 12e becomes capable of adequately carrying ink to the substrate 13.

Moreover, the single polyurethane layer 12c of the blanket sleeve 12 so produced is so consistent in regards to compressibility and surface tension that the sleeve 12 does not need to be individually categorized (A, B or C) like conventional blanket sleeves. Because of the consistency of the compressibility and surface tension of the inventive blanket sleeve 12, the operator of the offset printing press does not need to carry as many blanket sleeves in inventory. Because of the consistency of the compressibility and surface tension of the inventive blanket sleeve 12, in the event of a failure of an inventive blanket sleeve during operation of the offset printing press, the failed inventive blanket sleeve can be replaced more simply than if the operator was required to match the failed sleeve's rating of A, B, C. Accordingly, the operator of the offset printing press achieves more streamlined production when providing the offset printing press with the blanket sleeve 12 of the present invention.

Other variants of embodiments of the invention can be defined in the light of the present text. For example, instead of forming the inventive single polyurethane layer 12c on the surface of cylindrical portion 12a to form an inventive blanket sleeve 12, this single polyurethane layer 12c may just as easily be formed on the outer surface 25 of a mandrel 11 and thus yield an inventive blanket cylinder 10a as shown schematically in FIGS. 4 and 5. As shown schematically in FIG. 5, such an inventive blanket cylinder 10a with the inventive single layer 12c can be provided as part of an improved offset machine 14 for transferring data from the imaged surface 18 of a printing cylinder 19 to a substrate 13. Examples of machines 14 for which the inventive sleeves 12 and into which the inventive cylinders 10a are suitably incorporated, are disclosed in U.S. Pat. Nos. 5,440,981 and 5,429,048, which patents are hereby incorporated herein in their entirety for all purposes by this reference.

An inventive sleeve 12 and/or cylinder 10a with an inventive single layer 12c of polyurethane material has been described together with methods for making same and the incorporation of such cylinder 10a as part of an improved offset printing machine. Although various embodiments of the invention have been described using specific terms, devices, and methods, such description is for illustrative purposes only. The words used are words of description rather than of limitation. It is to be understood that changes and variations may be made by those of ordinary skill in the art without departing from the spirit or scope of the present invention. In addition, it should be understood that aspects of the various embodiments may be interchanged both in whole or in part. Therefore, the spirit and scope of the appended claims should not be limited to the description of the presently preferred versions contained therein.

What is claimed is:

1. A blanket sleeve, to be drawn over a rotary support in order to define a blanket cylinder of an indirect or offset printing machine, this blanket cylinder to cooperate with a lithographic plate cylinder from which the blanket cylinder receives the inked data to be printed and with a substrate onto which said inked data are to be transferred as said substrate moving between the blanket cylinder and a pressure cylinder, the blanket sleeve consisting essentially of:
an inner cylindrical portion configured to be drawn over the rotary support and defining an outer surface; and
a single layer formed on said outer surface of said inner cylindrical portion, said single layer being formed at least partly of polyurethane material and defining an exterior surface configured to cooperate with the lithographic plate and with the substrate to be printed wherein tiny cells constituting no less than about 0.6 percent by weight and no more than about 4.4 percent by weight are uniformly dispersed throughout the single layer.

2. A sleeve as in claim 1, wherein tiny cells constituting no less than about one percent by weight and no more than about two percent by weight are uniformly dispersed throughout the single layer.

3. A sleeve as in claim 1, wherein said single layer contains cells constituting about 1.2 percent by weight of said single layer.

4. A sleeve as in claim 1, wherein said single layer contains spherical bodies defining said cells and containing a gas.

5. A sleeve as in claim 4, wherein said spherical bodies are microspheres comprising an outer skin surrounding a space containing gaseous isobutane and said skin being composed of material including a thermoplastic resin.

6. A sleeve as in claim 5, wherein said thermoplastic resin includes a copolymer containing monomer units selected from the group consisting of vinylidene chloride, methacrylate and acrylonitrile.

7. A sleeve as in claim 4, wherein said spherical bodies are microspheres comprising a skin composed of material including a thermosetting resin of phenolic type.

8. A sleeve as in claim 1, wherein said single layer includes polyurethane material containing swelling agents.

9. A sleeve as in claim 8, wherein said swelling agents are of the type that release gas when heated.

10. A sleeve as in claim 1, wherein said single layer includes polyurethane material containing particles of water-soluble salts.

11. A sleeve as in claim 1, wherein said inner cylindrical portion is formed of one of metal and composite material; and
wherein said single layer has a hardness of between about 50° Shore A and about 75° Shore A, an average metric surface roughness in a range of about 1.0 Ra micrometers and about 7.0 Ra micrometers, a density of between about 0.6 kg/dm³ and 0.8 kg/dm³ and an ultimate elongation of between about 110% and about 130%.

12. A sleeve as in claim 1, wherein said inner cylindrical portion is formed of nickel; and
wherein said single layer has a hardness of about 60° Shore A, an average metric surface roughness of between about 3.0 Ra micrometers and about 5.0 Ra micrometers, a density of about 0.7 kg/dm³ and an ultimate elongation of about 120%.

13. A sleeve as in claim 1, wherein said polyurethane material is a polyether polyurethane.

14. A sleeve as in claim 1, wherein said polyurethane material is a polyester polyurethane.

15. A sleeve as in claim 1, wherein said single layer is formed of open cell polyurethane material.

16. A sleeve as in claim 1, wherein said single layer is formed of closed cell polyurethane material.

17. A sleeve as in claim 1, wherein said polyurethane material is elastomeric.

18. A sleeve as in claim 1, wherein said exterior surface of said single layer has an average metric surface roughness in a range of between about 3.0 Ra micrometers and about 5.0 Ra micrometers.

19. A sleeve as in claim 1, wherein said exterior surface of said single layer has an average metric surface roughness of about 4 Ra micrometers.

20. A sleeve as in claim 1, wherein said single layer has a radial thickness in a range of about one millimeter to about two millimeters.

21. A sleeve as in claim 1, wherein said single layer has a density of between about 0.6 kg/dm³ and 0.8 kg/dm³.

22. A sleeve as in claim 21, wherein said single layer has a density of about 0.7 kg/dm³.

23. A sleeve as in claim 1, wherein said single layer has a hardness of between about 50° Shore A and about 75° Shore A.

24. A sleeve as in claim 23, wherein said single layer has a hardness of about 60° Shore A.

25. A sleeve as in claim 1, wherein said single layer has an ultimate elongation of between about 110% and about 130%.

26. A sleeve as in claim 1, wherein said inner cylindrical portion is configured to be removably coupled to the rotary support.

27. A sleeve as in claim 1, wherein said inner cylindrical portion is configured to be integral with the rotary support.

28. A sleeve as in claim 1, wherein said inner cylindrical portion is formed of metal.

29. A sleeve as in claim 28, wherein said inner cylindrical portion is obtained from metal wire.

30. A sleeve as in claim 1, wherein said inner cylindrical portion is formed of composite material.

31. A sleeve as in claim 30, wherein said inner cylindrical portion is formed of a composite material containing at least one kind of fibers selected from the group of kinds of fibers consisting of carbon fibers, glass fibers, and aramid fibers.

32. A method for making a blanket cylinder of an offset printing machine that operates on a substrate, the method consisting essentially of the following steps:
a) providing a rigid body to define a rigid cylindrical surface portion; and
b) forming one blanket layer of polyurethane material carried by said cylindrical surface portion and defining a printing surface for receiving the inked data to be transferred to the substrate.

33. A method for making a blanket sleeve for the blanket cylinder of an offset printing machine that operates on a substrate, the method consisting essentially of the following steps:
a) providing a cylindrical body to define the inner cylindrical portion of the blanket sleeve; and
b) forming one blanket layer carried by said cylindrical body and defining a printing surface for receiving the inked data to be transferred to the substrate wherein said one blanket layer includes polyurethane material having tiny cells constituting no less than about 0.6 percent by weight and no more than about 4.4 percent by weight and uniformly dispersed throughout the one blanket layer.

34. A method as in claim 33, wherein said one blanket layer includes polyurethane material having tiny cells constituting no less than about one percent by weight and no more than about three percent by weight and uniformly dispersed throughout the single layer.

35. A sleeve as in claim 33, wherein said one blanket layer includes polyurethane material having tiny cells constituting about 1.2 percent by weight and uniformly dispersed throughout the single layer.

36. A method as in claim 33, wherein a cylindrical body formed of fiberglass embedded resin is provided to define said inner cylindrical portion.

37. A method as in claim 33, wherein said one blanket layer is provided by the steps comprising:
a) depositing on the outer surface of said inner cylindrical portion a polyurethane precursor material including a first component and a second component, the first component including polyol and non-expanding microspheres wherein the microspheres constitute between about 1 percent by weight of the first component and about 6 percent by weight of the first component, the second component including a curing agent for the polyol such that the weight ratio of the first component to the second component is in the range of about 100:30 to about 100:60; and
b) causing said polyurethane material to solidify on the outer surface of said inner cylindrical portion to define the one blanket layer of the sleeve.

38. A method as in claim 37, wherein said polyurethane precursor material includes by weight, about 100 parts polyol, about 50 parts curing agent and about 1.8 parts non-expanding microspheres.

39. A method as in claim 38, wherein said polyurethane material deposited on the outer surface of said inner cylindrical portion is a runny polyurethane material.

40. A method as in claim 38, wherein said solidification step is performed so that a portion of said one blanket layer disposed nearest said inner cylindrical portion includes cells and has a density of between about 0.6 kg/dm³ and about 0.8 kg/dm³.

41. A method as in claim 38, wherein said polyurethane material is deposited directly on the outer surface of said inner cylindrical portion in order to make the sleeve integral with the outer surface of said inner cylindrical portion.

42. A method as in claim 38, wherein said step of deposition of said polyurethane material on the cylindrical portion is carried out using ribbon flow technology.

43. A method as in claim 42, wherein deposition of said polyurethane material on said cylindrical portion is carried out by moving relative to each other said cylindrical portion and at least one nozzle from which said polyurethane material emerges, said movement taking place parallel to a longitudinal axis of said cylindrical portion.

44. A method as in claim 38, further comprising cross-linking said polyurethane material at ambient temperature and pressure, and thereafter grinding the surface of the single layer to become parallel.

45. A method as in claim 38, further comprising the step of polishing the parallel surface of the single layer to a uniform finish having an average metric surface roughness in a range of about 3.0 Ra micrometers to about 5.0 Ra micrometers.

46. A method as in claim 38, wherein said blanket layer is formed by the steps comprising:
a) using ribbon flow technology to deposit on said inner cylindrical portion a runny polyurethane material in a single pass along the length of said inner cylindrical portion; and
b) causing said polyurethane material to solidify to define a portion of said one blanket layer disposed nearest said outer printing layer of the sleeve having a density of between about 0.6 kg/dm³ and about 0.8 kg/dm³.

47. A method as in claim 38, wherein cross-linking said polyurethane material at ambient temperature and pressure occurs within 24 hours, and thereafter the surface of the one blanket layer is ground to a uniform finish having an average metric surface roughness in a range of about 3.0 Ra micrometers to about 5.0 Ra micrometers.

48. A method as in claim 47, wherein said deposition of said polyurethane material is implemented automatically.

49. An offset system for transferring data to a substrate, the system comprising:
an offset machine having a plurality of lithographic plate cylinders and a plurality of blanket cylinders, each blanket cylinder being configured and disposed to cooperate with a lithographic plate cylinder from which the blanket cylinder receives the data to be transferred to the substrate, each blanket cylinder consisting essentially of:
an inner cylindrical portion rotatably mounted on the printing machine and defining an outer surface; and
a single layer formed on said outer surface of said inner cylindrical portion, said single layer being formed at least partly of polyurethane material and defining an exterior surface configured to cooperate with the lithographic plate and with the substrate that is to receive the data and wherein tiny cells constituting no less than about 0.6 percent by weight of the single layer and no more than about 4.4 percent by weight of the single layer are uniformly dispersed throughout the single layer.
